(19) United States
(12) Patent Application Publication
(10) Pub. No.: US 2017/0146032 A1
(43) Pub. Date: May 25, 2017

(54) FAN FRAME AND HEAT DISSIPATION FAN HAVING THE SAME

(71) Applicants: CHAMP TECH OPTICAL (FOSHAN) CORPORATION, Foshan (CN); Foxconn Technology Co., Ltd., New Taipei (TW)

(72) Inventors: HSIEN-CHOU LIN, New Taipei (TW); XIAO-GUANG MA, Foshan (CN); YUNG-PING LIN, New Taipei (TW); CHIEN-NAN CHENG, New Taipei (TW); ZHENG LUO, Foshan (CN)

(21) Appl. No.: 15/218,288

(22) Filed: Jul. 25, 2016

(30) Foreign Application Priority Data
Nov. 24, 2015 (CN) 201510823982.9

(51) Int. Cl. F04D 29/66; F04D 25/08; F04D 29/02; F04D 29/40; F04D 29/26

(52) U.S. Cl. CPC F04D 29/668; F04D 29/403; F04D 29/26; F04D 29/023; F04D 25/08; F05B 2240/20; F05B 2240/14; F05B 2280/4004; F05B 2280/4003; F05B 2280/401

(57) ABSTRACT

A vibration-proofed fan frame includes a housing and a base surrounded by the housing. A hollow tube is arranged on the base and has the rotary connection with an impeller of the heat dissipation fan. The base includes a disc and a plurality of ribs extending outwards from periphery of the disc. The fan frame further includes a buffer member within the structural interconnections between the disc and the housing. The buffer member includes first elements. The first elements are embedded in the disc. A heat dissipation fan having the fan frame described is also presented.

### FIELD

The subject matter relates to a heat dissipation fan, and particularly relates to a fan frame and a heat dissipation fan having the same.

### BACKGROUND

A traditional fan includes a stator, a rotor, and a fan frame receiving the stator and the rotor. In operation, the rotor is driven by a motor to rotate relative to the stator, therefore dissipating heat generated from electronic elements. However, because of uneven mass distribution of the rotor and transformed moments of the motor, vibration and noise can be caused when the fan is working and stability of a heat sink including the fan is reduced.

### BRIEF DESCRIPTION OF THE DRAWINGS

Implementations of the present technology will now be described, by way of example only, with reference to the attached figures:

FIG. 1 is an assembly schematic view of a heat dissipation fan in accordance with a first exemplary embodiment of the present disclosure.

FIG. 2 is a cross-section view of the heat dissipation fan in FIG. 1, taken along the line II-II.

FIG. 3 is cross-section view of a heat dissipation fan in accordance with a second exemplary embodiment of the present disclosure.

FIG. 4 is cross-section view of a heat dissipation fan in accordance with a third exemplary embodiment of the present disclosure.

FIG. 5 is cross-section view of a heat dissipation fan in accordance with a fourth exemplary embodiment of the present disclosure.

FIG. 6 is cross-section view of a heat dissipation fan in accordance with a fifth exemplary embodiment of the present disclosure.

FIG. 7 is cross-section view of a heat dissipation fan in accordance with a sixth exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

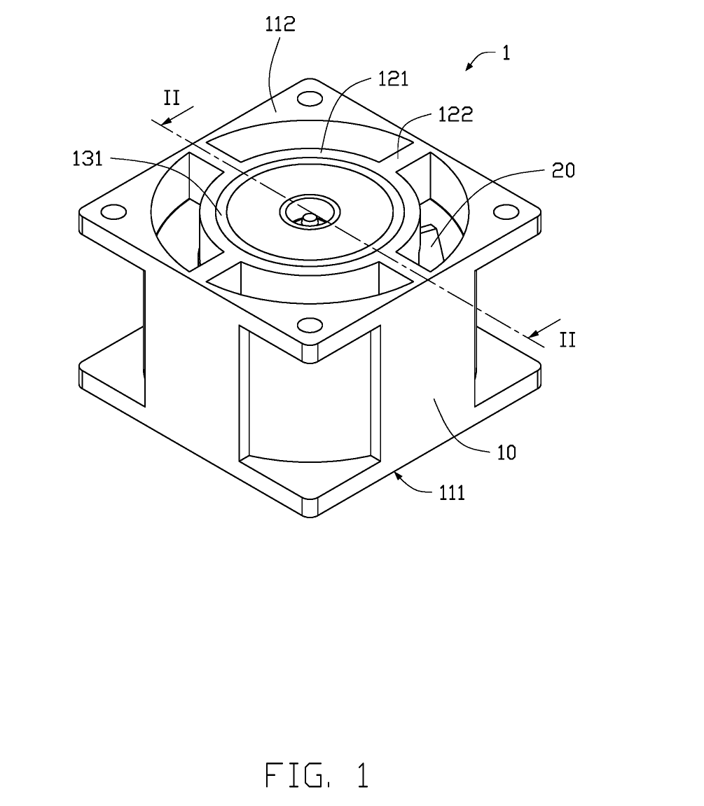

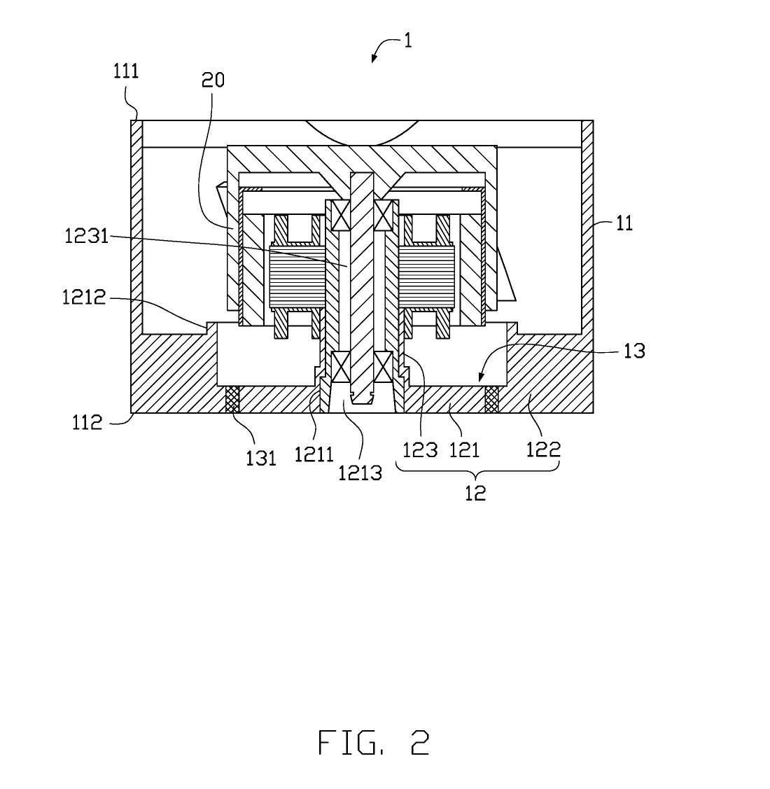

Referring to FIG. 1 and FIG. 2, a heat dissipation fan 1 of a first exemplary embodiment of the present disclosure includes a fan frame 10 and an impeller 20 received in the fan frame 10.

The heat dissipation fan 1 may be an aerofoil fan. The fan frame 10 includes a housing 11 and a base 12 surrounded by the housing 11.

The housing 11 is substantially cuboid-shaped. The housing 11 is hollow. The housing 11 includes a first end face 111 and a second end face 112. The first end face 111 and the second end face 112 are opposite to each other. The impeller 20 is received between the first end face 111 and the second end face 112.

The base 12 is arranged adjacent to the second end face 112 of the housing 11. A bottom face of the base 12 is coplanar with the second end face 112. The base 12 includes a disc 121, a plurality of ribs 122, and a hollow tube 123. The disc 121 is positioned at the center of the base 12. The ribs 122 interconnect the disc 121 and housing 11. The hollow tube 123 is formed at the center of the disc 121.

In this exemplary embodiment, the disc 121 is substantially cylindrical, and a cross-section of the disc 121 is substantially U-shaped. The disc 121 is hollow. A hole 1213 is defined at the center of the disc 121. The disc 121 includes an inner surface 1211 and an outer surface 1212. The inner surface 1211 is cylindrical and defines the hole 1213. In other words, the inner surface 1211 is an inner wall of the hole 1213. The outer surface 1212 is a periphery of the disc 121.

The ribs 122 are formed on the outer surface 1212 of the disc 121. The ribs 122 extend outwards from the outer surface 1212 of the disc 121 radially until interconnecting with an inner wall of the housing 11. Each rib 122 is substantially a thick and straight line. The ribs 122 are positioned adjacent to the second end face 112 of the housing 11.

The hollow tube 123 is formed on a top surface of the disc 121. The hollow tube 123 extends from a center part of the top surface of the disc 121 upwards. A channel 1231 is defined at the center of the hollow tube 123. The channel 1231 of the hollow tube 123 and the hole 1213 of the disc 121 are used for fixing and carrying the impeller 20. The hollow tube 123 has a rotary connection with the impeller 20.

The fan frame 10 can further include a buffer member 13. The buffer member 13 is made of damping material. The damping material may be silicon resin, rubber, plastic, sponge and so on.

In the first exemplary embodiment, the buffer member 13 includes a first buffer element 131. The first buffer element 131 is embedded in the disc 121. The first buffer element 131 is substantially annular. The first buffer element 131 is located between the inner surface 1211 and the outer surface 1212 of the disc 121. The first buffer element 131 is adjacent to the outer surface 1212. A distance between the first buffer element 131 and the outer surface 1212 is less than a distance between the first buffer element 131 and the inner surface 1211.

When the heat dissipation fan 1 is operating, the impeller 20 rotates, causing vibrations in the heat dissipation fan 1. The buffer member 13 is embedded in the fan frame 10, and is located a transmitting path of the vibrations caused by the impeller 20. The housing 11 is thus isolated from the vibrations. Since the housing 11 is used for connecting other cooling elements and is isolated from the vibration during operation, the connection between the housing 11 and the cooling elements is protected.

In other exemplary embodiments, the first buffer element 131 may have other shapes, such as rectangular frame, polygonal and so on. It is not limited to being annular.

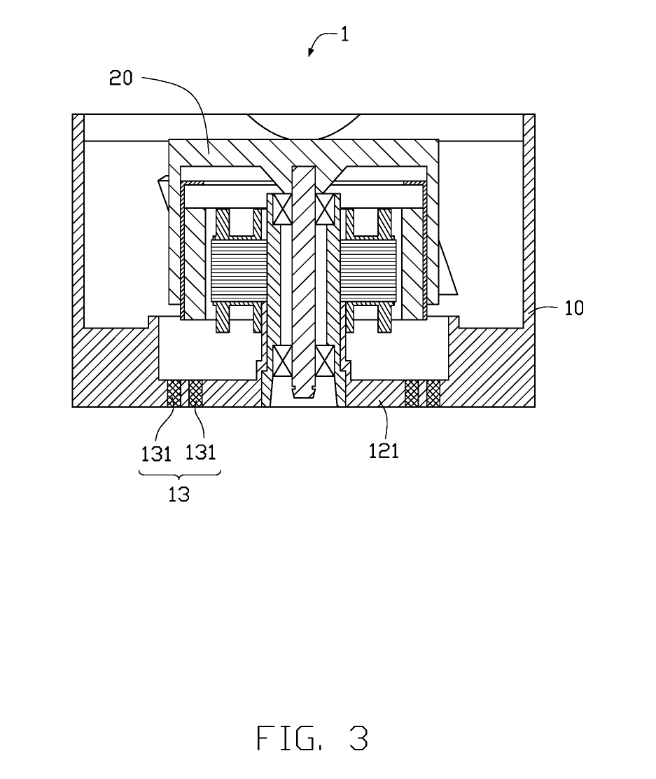

In the first exemplary embodiment, the quantity of the first buffer elements 131 is one. In other exemplary embodiments, the quantity of the first buffer elements 131 may be at least two. Referring to FIG. 3, a cross-section of the heat dissipation fan 1 in accordance with a second exemplary embodiment of the present disclosure is shown. In the second exemplary embodiment, the buffer member 13 includes two first buffer elements 131. The two first buffer elements 131 are substantially annular. The two first buffer elements 131 are concentrically arranged. The two first buffer elements 131 are isolated from each other.

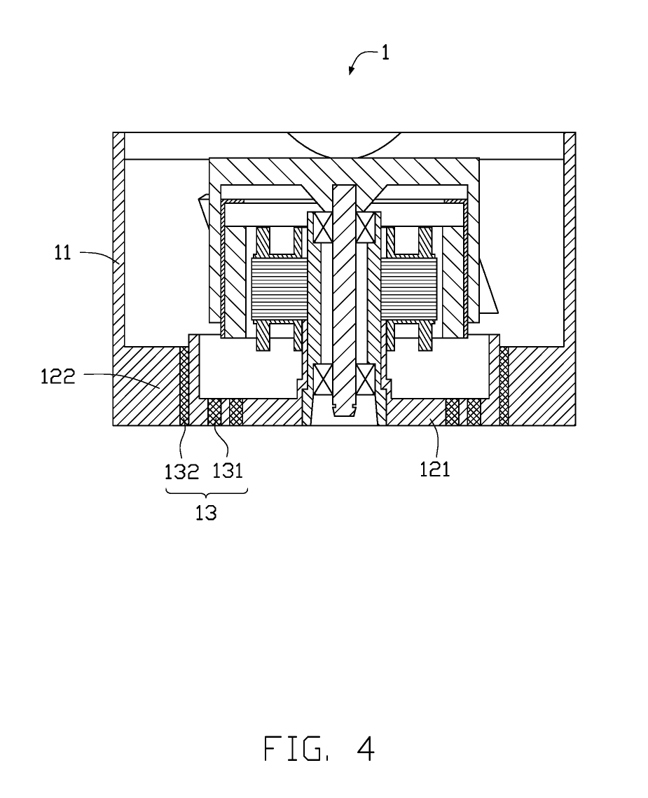

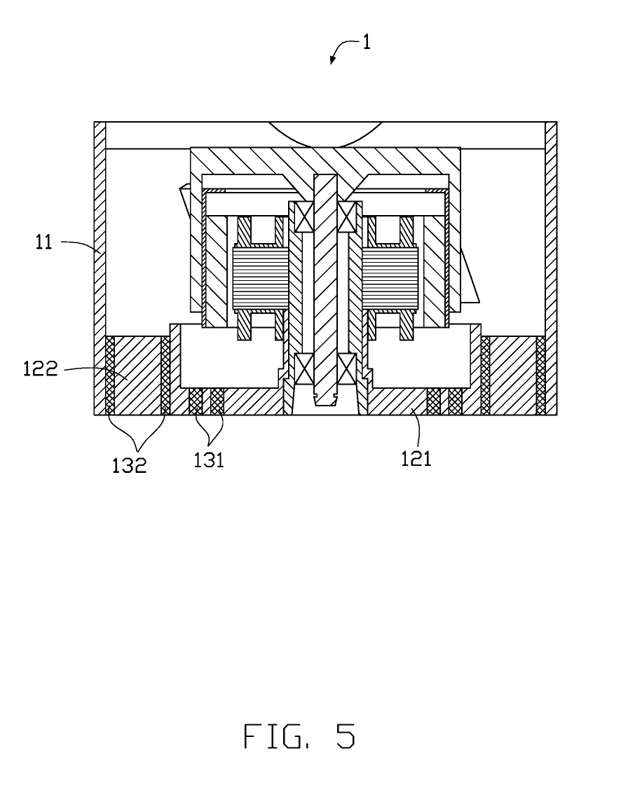

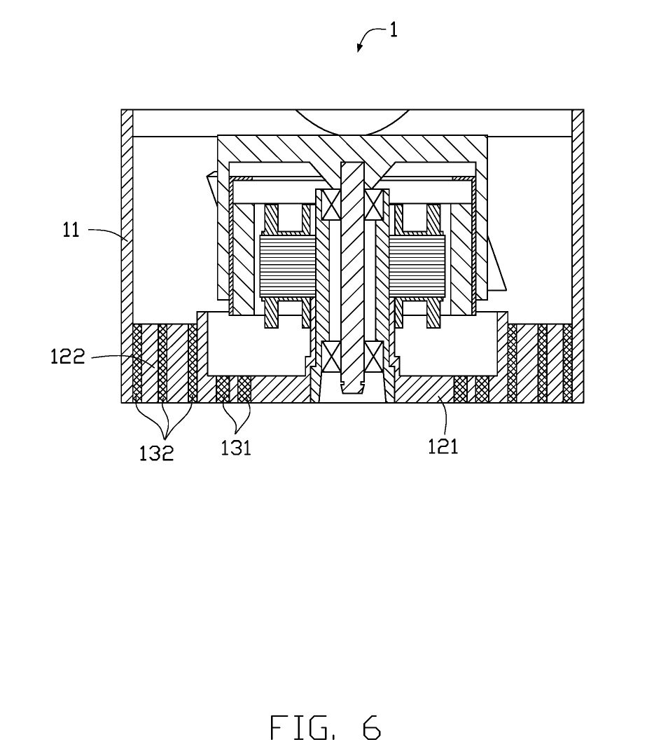

Referring to FIG. 4 to FIG. 6, the buffer member 13 further includes a plurality of second buffer elements 132. The quantity of the second buffer elements 132 may be one, two or three. The second buffer elements 132 are embedded in the ribs 122. The second buffer elements 132 concentrically surround the first buffer elements 131. The second buffer element 132 may be positioned at connecting portions of the ribs 122 which are connected to the disc 121 (as shown in FIG. 4). The second buffer element 132 may be positioned at connecting portions of the ribs 122 which are connected to the housing 11 (as shown in FIG. 5). The second buffer element 132 may be positioned at central portions of the ribs 122 which are between the housing 11 and the disc 121 (as shown in FIG. 6). The parts of each second buffer element 132 embedded in the ribs 122 are located at one circumference.

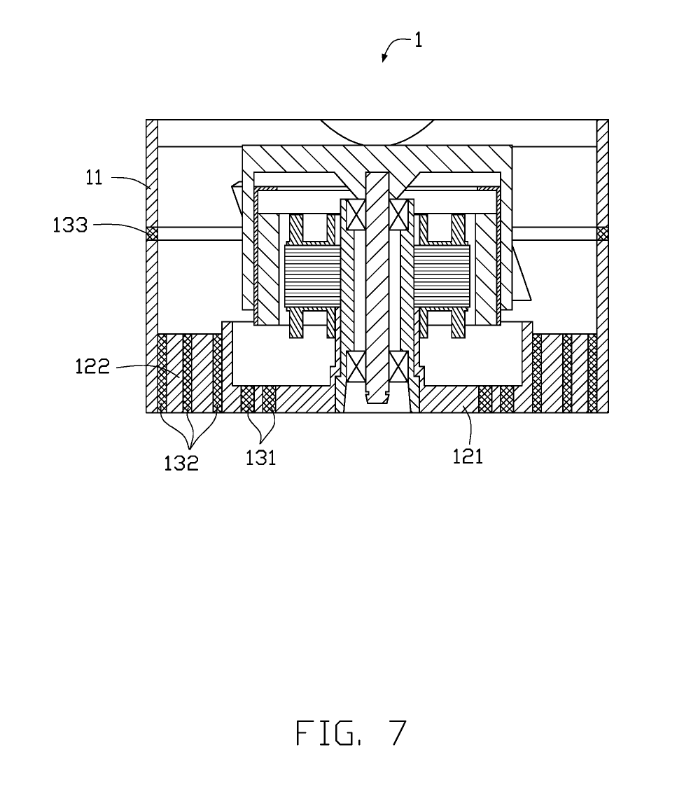

Referring to FIG. 7, the buffer member 13 may further includes at least a third buffer element 133. The third buffer element 133 is embedded in the housing 11. A shape of the third buffer element 133 is substantially the same as the housing 11. In the sixth embodiment, a quantity of the third buffer elements 133 is one. The third buffer element 133 is also substantially a rectangular ring. The third buffer element 133 is positioned above and outside the first buffer elements 131 and the second buffer elements 132. In other embodiments, the third buffer element 133 may also be positioned to surround the first buffer elements 131 and the second buffer elements 132.

The embodiments shown and described above are only examples. Many details are often found in the art such as the other features of the fan frame. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A fan frame, comprising:
a housing;
a base surrounded by the housing, the base comprising:
a disc;
a hollow tube mounted on the disc, the hollow tube having a rotary connection with an impeller of a heat dissipation fan; and
a plurality of ribs extending outwards from periphery of the disc, the ribs interconnecting the housing and the disc; and
a buffer member comprising:
a first buffer element embedded in the disc.

2. The fan frame of claim 1, wherein the disc comprises an inner surface and an outer surface, the inner surface defines a hole at the center of the disc, the outer surface is periphery of the disc, the first buffer element is located between the inner surface and the outer surface.

3. The fan frame of claim 2, wherein a distance between each first buffer element and the outer surface is less than a distance between the corresponding first buffer element and the inner surface.

4. The fan frame of claim 3, wherein a number of the first buffer element is one, the first buffer element is annular.

5. The fan frame of claim 3, wherein a number of the first buffer element is two or more, each first buffer element is annular, the plurality of the first buffer elements are concentric and isolated from each other.

6. The fan frame of claim 1, wherein the buffer member further comprises a second buffer element embedded in the ribs.

7. The fan frame of claim 6, wherein a number of the second buffer element is two or more, one of the second buffer elements is positioned at connecting portions of the ribs which are connected to the disc.

8. The fan frame of claim 7, wherein a number of the second buffer element is two or more, one of the second buffer elements is positioned on connecting portions of the ribs which are connected to the housing.

9. The fan frame of claim 8, wherein a number of the second buffer element is two or more, one of the second buffer elements is positioned on central portions of the ribs which are between the housing and the disc.

10. The fan frame of claim 9, wherein parts of each second buffer element embedded in the ribs are located at one circumference.

11. The fan frame of claim 1, wherein the buffer member further comprises a third buffer element embedded in the housing.

12. The fan frame of claim 1, wherein the buffer member is made of damping material, and the damping material is made of materials selected from one of silicon resin, rubber, plastic or sponge.

13. A heat dissipation fan, comprising:
a fan frame comprising:
a housing;
a base surrounded by the housing, the base comprising:
a disc;
a hollow tube formed at the center of the disc; and
a plurality of ribs extending outwards from periphery of the disc, the ribs interconnecting the housing and the disc; and
a buffer member comprising:
a first buffer element embedded in the disc; and
an impeller received in the fan frame, the hollow tube having a rotary connection with the impeller.

14. The heat dissipation fan of claim 13, wherein the disc comprises an inner surface and an outer surface, the inner surface defines a hole at the center of the disc, the outer surface is periphery of the disc, the first buffer element is located between the inner surface and the outer surface.

15. The fan frame of claim 14, wherein a distance between each first buffer element and the outer surface is less than a distance between the corresponding first buffer element and the inner surface.

16. The heat dissipation fan of claim 13, wherein the buffer member further comprises a second buffer element embedded in the ribs.

17. The heat dissipation fan of claim 16, wherein a number of the second buffer element is two or more, one of the second buffer elements is positioned on connecting portions of the ribs which are connected to the disc.

18. The heat dissipation fan of claim 17, wherein a number of the second buffer element is two or more, one of the second buffer elements is positioned on connecting portions of the ribs which are connected to the housing.

19. The heat dissipation fan of claim 18, wherein a number of the second buffer element is two or more, one of the second buffer elements is positioned on central portions of the ribs which are between the housing and the disc.

20. The heat dissipation fan of claim 14, wherein the buffer member further comprises a third buffer element embedded in the housing.
